(19) United States
(12) Patent Application Publication
(10) Pub. No.: US 2005/0190124 A1
(43) Pub. Date: Sep. 1, 2005

(54) Subfield coding circuit, image signal processing circuit, and plasma display

(75) Inventor: Takashi Manabe, Izumi (JP)

Correspondence Address: MCGINN & GIBB, PLLC, 8321 OLD COURTHOUSE ROAD, SUITE 200, VIENNA, VA, 22182-3817, US

(73) Assignee: Pioneer Plasma Display Corporation, Izumi (JP)

(21) Appl. No.: 11/053,201

(22) Filed: Feb. 9, 2005

(30) Foreign Application Priority Data
Feb. 10, 2004 (JP) 2004-34271

(51) Int. Cl. G09G 3/28

(52) U.S. Cl. 345/63

(57) ABSTRACT

A subfield (SF) coding circuit including an SF coding cache memory, a look-up table (LUT) memory, and an SF coding control unit. The coding control unit reads setting gradation values and SF coding data from the coding cache memory for writing to the LUT memory SF by SF. The control unit accesses the LUT memory by using the gradation value of an image signal from a frame memory control unit as an address, and outputs the SF coding data corresponding to the gradation value of the image signal input to the LUT memory to a serial-to-parallel conversion unit.

### BACKGROUND OF THE INVENTION

1. Field of the Invention

The present invention relates to a subfield coding circuit for converting an input image signal (RGB image signal) into subfield coding data, an image signal processing circuit, and a plasma display apparatus.

2. Description of the Related Art

Among examples of display devices having a flat-panel display are plasma display panels (PDPs), organic/inorganic electroluminescence (EL) panels, and projection panels using direct mirror devices (DMDs).

In these display devices, each individual display cell can only take two values, or “light emission” and “non-emission.” Tone gradations are thus rendered by controlling the numbers of times of light emission from the respective display cells. Take, for example, the case of 8-bit tone or 8-bit gradation rendering with R (red), G (green), and B (blue) display cells for use in color display. The numbers of times of light emission from the respective display cells are controlled to appropriate values between 0 and 255 (or integral multiples of integers 0 to 255, and integers close to those values) to render halftones. As a result, it becomes possible to display natural images. Hereinafter, each of the individual R, G, and B display cells will be referred to as a color cell. A group of display cells consisting of R, G, and B color cells will be referred to collectively as a pixel.

The display devices that render gradations thus by controlling the numbers of times of light emission from the display cells typically employ a subframe method (subfield method). The subframe method (subfield method) refers to processing in which a single frame (or a single field) of image is displayed by dividing the single frame (or single field) into a plurality of subframes (or subfields), and assigning the numbers of times of light emission to the respective subframes (or subfields). Such processing is also referred to as subframe coding processing (subfield coding processing). Hereinafter, for the sake of simplicity, the term “frame” shall also imply “field.” A subframe will be abbreviated as SF.

For example, the foregoing 8-bit gradation rendering for each of the color cells has been achieved by the following technique. That is, the numbers of times of light emission of 1, 2, 4, 8, 16, 32, 64, and 128 are assigned to eight SFs within a single frame, or SF1 the first to be displayed to SF8 the last (eighth) to be displayed, respectively. Then, light emission/non-emission control is performed in each SF with respect to each of the color cells independently.

Now, take the case of a display device that has relatively longer display periods per SF (display devices that consume most of the time of a single frame period to emit light for display), such as a PDP in particular. There has been the problem that when the gradation rendering is achieved by using the SFs divided as many as the number of bits of the input image signal (image data) as described above, there may occur a degradation in image quality called a moving-image false contouring.

On this account, a technique called “redundancy coding” has been typically employed in order to avoid the degradation in image quality due to the occurrence of moving-image false contour.

The redundancy coding satisfies the relationship n>log₂ N, where N is the number of tones or gradations (gradation levels) of the image signal (input image signal), and n is the number of SFs included in a single frame. In an actual PDP, for example, a value of 11 or 12 is used as the number n of SFs with respect to the input of an 8-bit image signal (the number of gradations N=256). For the input of a 10-bit image signal (the number of gradations N=1024), a value of 13 is used as the number n of SFs.

The input image signal to a display is usually input in a manner conforming to the CRT (Cathode Ray Tube) display system which has conventionally been the most common. That is, a single frame (a screenful) of input image signal (image data) is input in order from the image data corresponding to the top scan line to the image data corresponding to the bottom scan line successively on the display screen. Meanwhile, the image data corresponding to each scan line is input in order from the image data corresponding to the color cell on the left end to that corresponding to the color cell on the right end of the scan line.

In contrast to this, the displays for giving a display of the SF method require the following. That is, emission/non-emission information with respect to each individual pixel (information on gradation values) across a single frame (a screenful) of SFs (e.g., SF1 to SF11 or SF12) be input to the display device in advance before the first SF to be displayed within the single frame (i.e., SF1) is rendered or displayed. A frame memory is thus indispensable to the displays using the SF method. More specifically, a single frame of image signals which are input in conformity to the order of scan of CRT as described above and given SF coding are once retained (buffered) in the frame memory before output to the display device (for example, see FIG. 3 in Japanese Patent Laid-Open Publication Kokai No. 2003-15594).

Now, description will be given of a plasma display as an example of the displays. The plasma display apparatus includes a display device. The display device has a PDP, a scan driver, a data driver, and a high-voltage pulse unit.

The high-voltage pulse unit supplies a pulsed voltage to the PDP and the scan driver.

The PDP has pixels arranged in a matrix. Scan electrodes are provided on the rows, and data electrodes on the columns.

The scan driver receives a scan driver control signal for controlling the scan driver, through the high-voltage pulse unit. The scan driver controls and drives the scan electrodes in accordance with the scan driver control signal.

The data driver receives a data driver control signal for controlling the data driver. The data driver controls and drives the data electrodes in accordance with the data driver control signal.

The PDP displays a desired image by turning on or turning off predetermined pixels among those arranged in a matrix, based on the control of the scan electrodes by the scan driver and the control of the data electrodes by the data driver.

The plasma display further includes an image signal processing circuit according to a first prior art example. FIG. 1 is a block diagram showing the configuration of the image signal processing circuit according to the first prior art example.

As shown in FIG. 1, the image signal processing circuit according to the first prior art example includes a video signal processing unit 131, an SF coding circuit 132, a frame memory control unit 133, a serial-to-parallel conversion unit 134, and a frame memory 135.

Among the individual components of the image signal processing circuit according to the first prior art example, those excluding the frame memory 135 are implemented on a signal processing LSI (Large-Scale Integrated circuit) 123. This signal processing LSI 123 (signal processing LSI chip 123) is mounted on a digital board 125 along with the frame memory 135.

Description will now be given of the operation of the image signal processing circuit according to the first prior art example.

The R (red), G (green), and B (blue) image signals (R, G, and B in 10 bits each) are input to the signal processing LSI 123. These image signals are previously given gamma conversion. The video signal processing unit 131 applies video signal processing to the input image signals. For the video signal processing, the video signal processing unit 131 performs inverse gamma conversion on the input image signals, applies gradation processing to the image signals given the inverse gamma conversion, and outputs the resultant signal to the SF coding circuit 132. The gradation processing uses known dither and error diffusion methods.

The SF coding circuit 132 applies SF coding processing to the image signals from the video signal processing unit 131. For the SF coding processing, the SF coding circuit 132 converts the image signals from the video signal processing unit 131 into SF coding data, and outputs the same to the frame memory control unit 133.

The frame memory control unit 133 converts the SF coding data from the SF coding circuit 132 into signals suitable for write to the frame memory 135, and writes (temporarily stores) the same to the frame memory 135.

The frame memory control unit 133 reads the SF coding data temporarily stored in the frame memory 135 at predetermined timing scan line by scan line, and outputs it to the serial-to-parallel conversion unit 134.

The serial-to-parallel conversion unit 134 applies serial-to-parallel conversion processing to the SF coding data from the frame memory control unit 133. For the serial-to-parallel conversion processing, the serial-to-parallel conversion unit 134 converts the SF coding data from the frame memory control unit 133 into data configured as required by the data driver, and outputs it to the data driver as the foregoing data driver control signal.

As shown in FIG. 2, the SF coding circuit 132 has static random access memories (SRAMs) 161. In a generally known method, the SRAMs 161 are used as look-up table (LUT) memories. Initially, possible gradation values of the image signals and the SF coding data are written to the SRAMs 161 (LUT memories) SF by SF in advance. Then, the SF coding circuit 132 accesses the SRAMs 161 (LUT memories) by using the input image signals as addresses, and reads the SF coding data corresponding to the input image signals from the SRAMs 161 (LUT memories) for output.

For example, take the case where the inputs are in 10 bits and the number of division of SFs is 13. Since the number of words in the address direction is 1024 (10 bits) and the data bit width is 13 bits, an LUT memory 161 has a memory capacity (SRAM capacity) of 13 Kbits. The input image signals (R, G, and B) thus require three LUT memories 161 each having the SRAM capacity of 13 Kbits.

In contrast, Japanese Patent Publication Kokai No. 2003-15594 has proposed the method of accessing an SRAM in a time-sharing fashion, thereby sharing a single LUT memory 161 among R, G, and B. The number of LUT memories 161 is thus reduced to ⅓.

Here, assuming an example of W-XGA display with 1365 pixels per scan line and 768 lines per frame, the memory capacity of the frame memory 135 is expressed by the following equation (1):
Memory capacity: 1365×768×3n×2=approximately 6×n (Mb). (1)

Among the values multiplied in the foregoing equation (1), “1365” is the number of pixels per scan line. The value “768” is the number of scan lines per frame. The value “3” corresponds to the number of color cells included in a single pixel (three, i.e., R, G, and B). The value “n” corresponds to the number of SFs per frame. The value “2” is one determined in view of double buffering necessary to write and read a single frame of data simultaneously.

As described above, the number “n” of division of SFs in the PDP is 13, for example. From the foregoing equation (1), it is derived that a frame memory capacity of 78 Mb is required here.

For smooth display operation, it is also necessary to provide a memory bus bandwidth capable of data transfer at transfer rates such that image signals as much as the capacity determined by the foregoing equation (1) can be input (written) to and output (read) from the frame memory within a single frame period.

By the way, a single frame period, if in the case of 60-Hz display, is equivalent to 1/60=approximately 16.67 ms (milliseconds). Display devices such as a PDP require priming periods, scan periods (display data write periods), and emission sustaining periods within a single frame period as shown in FIG. 3 for image display. The periods available to write and read image data to/from the frame memory are thus only part of the display period for a single frame. Besides, the time necessary to read and write a single frame of image data from/to the frame memory is closely related to the scan periods. In fact, the maximum memory bus bandwidth is determined by the scan cycle (scan cycle; the time necessary to write a single horizontal line of pixel data to the display device). That is, the scan cycle determines the data read speed from the frame memory. Then, while image signals are sent and received between the frame memory control unit 133 and the frame memory 135, the maximum memory bus bandwidth is typically required in reading data from the frame memory 135. Incidentally, existing PDPs have scan cycles around 1 μs (microsecond) to 2 μs per line because of emission and electric characteristics of the color cells. Consequently, given a scan cycle of 1 μs, for example, the maximum memory bus bandwidth required for W-XGA display is defined by the following equation (2):
Maximum memory bus bandwidth: 1365×3×2/1 (μs)=approximately 8.2 (Gb/s). (2)

Among the values multiplied in the foregoing equation (2), “1365” is the number of pixels per scan line. The value “3” is the number of color cells included in a single pixel (three, i.e., R, G, and B). The value “2” is one determined in view of double buffering necessary to write and read a single frame of data simultaneously.

Moreover, in the case of a dual scan system in which two lines of data is written to the display device at a time, the maximum memory bus bandwidth must be twice the value defined by the foregoing equation (2).

When the frame memory 135 (also referred to as frame buffer) is made of a memory LSI, a dynamic random access memory (DRAM) is typically used in order to secure the capacity defined by the foregoing equation (1).

Take, for example, the case of W-XGA display in which the number of division of SFs is 13 and the scan cycle is 1 μs. A synchronous DRAM currently in the mainstream, with 128 Mb and 32 IOs (may also be indicated as ×32), can be operated at 256 MHz to constitute the frame memory which satisfies both the conditions of the foregoing equations (1) and (2). With a double data rate synchronous DRAM, one having 128 Mb and 32 IOs can be operated at 128 MHz to constitute the frame memory which satisfies both the conditions of the foregoing equations (1) and (2).

As described above, the image signal processing circuit according to the first prior art example is composed of the signal processing LSI chip 123 and the dedicated DRAM chip [external memory (frame memory 135)]. With the advance of the semiconductor processes in recent years, an image signal processing circuit comprising a DRAM-implemented LSI (LSI chip) has been achieved (the image signal processing circuit according to a second prior art example).

The DRAM on the DRAM-implemented LSI chip is advantageous in that it is capable of high speed operation (parallel accesses at high speed in particular) and it has a greater number of ports. The DRAM has the disadvantage, however, that the maximum possible memory capacity is not as high as that of the dedicated DRAM chip (external memory). The dedicated DRAM chip (external memory), on the other hand, has the advantage of the high capacity (the maximum possible memory capacity is high), though with the disadvantage that the maximum number of ports available is 32.

Description will now be given of the image signal processing circuit according to the second prior art example. The plasma display further includes the image signal processing circuit according to the second prior art example instead of the image signal processing circuit according to the first prior art example. FIG. 4 is a block diagram showing the configuration of the image signal processing circuit according to the second prior art example.

As shown in FIG. 4, the image signal processing circuit according to the second prior art example includes a video signal processing unit 231, an SF coding circuit 232, a frame memory control unit 233, a serial-to-parallel conversion unit 234, and a frame memory 235.

All the components of the image signal processing circuit according to the second prior art example are implemented on a signal processing LSI 223 (signal processing LSI chip 223).

Description will now be given of the operation of the image signal processing circuit according to the second prior art example.

R (red), G (green), and B (blue) image signals (R, G, and B in 10 bits each) are input to the signal processing LSI 223. These image signals are already given gamma conversion. The video signal processing unit 231 applies video signal processing to the input image signals. For the video signal processing, the video signal processing unit 231 performs inverse gamma conversion on the input image signals, applies gradation processing to the image signals given the inverse gamma conversion, and outputs the resultant to the frame memory control unit 233. As in the first prior art example, the gradation processing uses known dither and error diffusion methods.

The frame memory control unit 233 converts the image signals from the video signal processing unit 231 into signals suitable for write to the frame memory 235, and writes (temporarily stores) the same to the frame memory 235.

The frame memory control unit 233 reads the image signals temporarily stored in the frame memory 235 at predetermined timing scan line by scan line, and outputs them to the SF coding circuit 232.

The SF coding circuit 232 applies SF coding processing to the image signals from the frame memory control unit 233. For the SF coding processing, the SF coding circuit 232 converts the image signals from the frame memory control unit 233 into SF coding data, and outputs the same to the serial-to-parallel conversion unit 234.

The serial-to-parallel conversion unit 234 applies serial-to-parallel conversion processing to the SF coding data from the SF coding circuit 232. For the serial-to-parallel conversion processing, the serial-to-parallel conversion unit 234 converts the SF coding data from the SF coding circuit 232 into data configured as required by the data driver, and outputs it to the data driver as the foregoing data driver control signal.

Here, as shown in FIG. 2, the SF coding circuit 232 has SRAMs 161 as is the case with the SF coding circuit 132 of the first prior art example. The SRAMs 161 are used as look-up table (LUT) memories. Initially, possible gradation values of the image signals and the SF coding data are written to the SRAMs 161 (LUT memories) in advance. Next, the SF coding circuit 232 accesses the SRAMs 161 (LUT memories) with the input image signals as addresses, and reads the SF coding data corresponding to the input image signals from the SRAMs 161 (LUT memories) for output.

In the image signal processing circuit according to the second prior art example, the SF coding circuit (SF coding circuit 232) is arranged after the frame memory (frame memory 235). Thus, the data to be stored into the frame memory is the image signals given the video signal processing according to the second prior art example, instead of the SF coding data given the redundancy coding according to the first prior art example. This allows a reduction in the memory capacity required of the frame memory.

Here, assuming an example of W-XGA display with 1365 pixels per scan line and 768 lines per frame, the memory capacity required of the frame memory 235 is expressed by the following equation (3):
Memory capacity: 1365×768×3×m×2=approximately 6×m (Mb). (3)

Among the values multiplied in the foregoing equation (3), “1365” is the number of pixels per scan line. The value “768” is the number of scan lines per frame. The value “3” corresponds to the number of color cells included in a single pixel (three, i.e., R, G, and B). The value “m” is the number of bits of the input image signals. The value “2” is one determined in view of double buffering necessary to write and read a single frame of data simultaneously.

The frame memory 235 (also referred to as frame buffer) is typically made of a DRAM for the sake of securing the memory capacity defined by the foregoing equation (3).

Suppose, for example, that the input image signals are in 10 bits and the number of division of SFs is 13. From the equation (3), the memory capacity required of the frame memory 235 according to the second prior art example is 60 Mb. This allows a reduction of 18 Mb as compared to the memory capacity of 78 Mb which is required of the frame memory 135 according to the first prior art example.

Nevertheless, while in the first prior art example the SF coding data for a single SF is read from the frame memory 135 SF by SF, it is the intact input image signals that must be read from the frame memory 235 in the second prior art example. This means an increase in the memory bus bandwidth.

For example, assuming W-XGA display of dual scan system with a scan cycle of 1 μs, the maximum memory bus bandwidth is defined by the following equation (4):
Maximum memory bus bandwidth: 1365×3×2×m/1 (μs)=approximately 8.2×m (Gb/s). (4)

Among the values multiplied in the foregoing equation (4), “1365” is the number of pixels per scan line. The value “3” is the number of color cells included in a single pixel (three, i.e., R, G, and B). The value “2” is one determined in view of double buffering necessary to write and read a single frame of data simultaneously. The value “m” is the number of bits of the input image signals.

For example, assuming W-XGA display of dual scan system with input image data of 8 bits and a scan cycle of 1 μs, the equation (4) yields a bus bandwidth of approximately 65.5 Gb/s.

When a DRAM (frame memory 235) having a memory capacity of 60 Mb is operated at 100 MHz, the equation (4) can be satisfied with 656 ports of data input and output.

The image signal processing circuit according to the second prior art example, however, has the problem that the SRAMs 161 used as the LUT memory of the SF coding circuit 232 increase in memory capacity.

Take, for example, the case of W-XGA display of dual scan system in which the input image signals are in 8 bits, the number of division of SFs is 13, the scan cycle is 1 μs, and the operating speed of the frame memory 235 is 100 MHz. Here, the number of input signals of the SF coding circuit 233 is 656 bits. This requires as many the foregoing SRAM 161 (13 Kbits) as eighty two, so that the total memory capacity of the SRAMs 161 is 1066 Kbits.

Now, take the case of using such an SF coding system as disclosed in Japanese Patent Publication Kokai No. 2003-15594, where the SRAMs 161 are accessed in a time-sharing manner. Even when the SRAMs have an operating speed of 300 MHz, or three times that of the frame memory, as many the foregoing SRAM 161 (13 Kbits) as twenty eight are required. The total memory capacity of the SRAMs 161 can only be reduced to 364 Kbits.

### SUMMARY OF THE INVENTION

It is an object of the present invention to provide a subfield coding circuit, an image signal processing circuit, and a plasma display which allow a reduction in memory capacity.

It is another object of the present invention to provide a subfield coding circuit, an image signal processing circuit, and a plasma display which are capable of high speed operation.

It is still another object of the present invention to provide a subfield coding circuit, an image signal processing circuit, and a plasma display which allow a reduction in the area of the LSI chip.

Hereinafter, means for solving the problems will be described in conjunction with numerals and symbols employed in “DETAILED DESCRIPTION OF THE INVENTION.” These numerals and symbols are given in order to clarify the correspondence between the descriptions in “CLAIMS” and the descriptions in “DETAILED DESCRIPTION OF THE INVENTION,” whereas they must not be employed to interpret the technical scope of the invention set forth in “CLAIMS.”

A subfield coding circuit (32) of the present invention is applied to an image signal processing circuit (30). The image signal processing circuit (30) of the present invention is applied to a plasma display (20).

The plasma display (20) of the present invention includes the image signal processing circuit (30), and a display unit (24) connected to the image signal processing circuit (30).

The image signal processing circuit (30) includes a frame memory (35), a frame memory control unit (33), and the subfield coding circuit (32). The frame memory control unit (33) stores an image signal into the frame memory (35), and reads and outputs the image signal stored in the frame memory (35) scan line by scan line. The subfield coding circuit (32) applies subfield coding processing to the image signal from the frame memory control unit (33), and outputs the resultant to the display unit (24).

The subfield coding circuit (32) includes a cache memory (41), a subfield coding memory (42), and a subfield coding control unit (43). The cache memory (41) contains setting gradation values (70), or predetermined gradation values of the image signal, and subfield coding data (71-j; j=1, 2, . . . , 13) in association with each other with subfield by subfield (SFj). The subfield coding memory (42) inputs the image signal from the frame memory control unit (33). The subfield coding control unit (43) reads the setting gradation values (70) and the subfield coding data (71-j) from the cache memory (41) and writes the same to the subfield coding memory (42) with respect to each of the subfields (SFj). The subfield coding control unit (43) accesses the subfield coding memory (42) with the gradation value of the input image signal as an address, and outputs subfield coding data (71-j) from among the setting gradation values (70) corresponding to the gradation value of the input image signal with respect to each of the subfields (SFj).

According to the plasma display (20) of the present invention, the subfield coding memory (42) is given a memory capacity as much as a single subfield with the configuration described above. This can reduce the memory capacity inside the subfield coding circuit (32) [the total memory capacity of the subfield coding circuit (32)].

The plasma display (20) of the present invention further includes a display control unit (21). The display control unit (21) outputs a cache data rewrite signal (65) to the subfield coding control unit (43) for each of the subfields (SFj).

The subfield coding control unit (43) reads the setting gradation values (70) and the subfield coding data (71-j) from the cache memory (41) and writes the same to the subfield coding memory (42) in accordance with the cache data rewrite signal (65).

The display control unit (21) outputs a subfield number signal (67) and the cache data rewrite signal (65) to the subfield coding control unit (43) for each of the subfields (SFj).

When the subfield number (67) indicates a first subfield (SF1) out of the subfields (SF1 to SF13), the subfield coding control unit (43) reads the setting gradation values (70) and the subfield coding data (71-1) corresponding to the first subfield (SF1) indicated by the subfield number signal (67) from the cache memory (41) and writes the same to the subfield coding memory (42) in accordance with the subfield number signal (67) and the cache data rewrite signal (65).

The display control unit (21) outputs a subfield coding start signal (66) to the subfield coding control unit (43) for each of the subfields (SFj).

The subfield coding control unit (43) accesses the subfield coding memory (42) with the gradation value of the input image signal as an address in accordance with the subfield coding start signal (66), and outputs the corresponding subfield coding data (71-j).

The display control unit (21) outputs the subfield number signal (67) and the cache data rewrite signal (65) to the subfield coding control unit (43) before a scan period of the first subfield (SF1). The display control unit (21) outputs the subfield coding start signal (66) to the subfield coding control unit (43) during the scan period of the first subfield (SF1).

The image signal processing circuit (30) is implemented on an LSI chip (23). The frame memory (35) is a dynamic random access memory (DRAM). The subfield coding memory (42) is a static random access memory (SRAM).

In general, the frame memory (DRAM) on an LSI chip is capable of high speed operation (parallel accesses at high speed in particular), and has a greater number of ports. Its maximum possible memory capacity, however, is not as high as that of a dedicated DRAM chip [external memory; the frame memory (135) (DRAM) according to the first prior art example]. According to the plasma display (20) of the present invention, the subfield coding circuit (32) is arranged after the frame memory (35). This can reduce the memory capacity required of the frame memory (35) (DRAM) as compared to that of the frame memory (135) (DRAM) of the foregoing first prior art example. Since the subfield coding circuit (32) is arranged after the frame memory (35), however, the SRAM of the subfield coding circuit (32) may increase in memory capacity. According to the plasma display (20) of the present invention, the memory capacity of the subfield coding memory (42) (SRAM) in the subfield coding circuit (32) is further reduced so that the image signal processing circuit (30) implemented on the LSI chip (23) can be operated at high speed.

According to the plasma display (20) of the present invention, the memory capacity required of the frame memory (35) (DRAM) and the memory capacity inside the subfield coding circuit (32) both can be reduced. It is therefore possible to reduce the area of the LSI chip (23) by an amount corresponding to the reduction in the memory capacity. According to the plasma display (20) of the present invention, the reduced area of the LSI chip (23) allows a reduction in the cost (for example, manufacturing cost) of the LSI chip (23).

As a result of the foregoing, the subfield coding circuit, the image signal processing circuit, and the plasma display of the present invention allow a reduction in memory capacity.

The subfield coding circuit, the image signal processing circuit, and the plasma display of the present invention can be operated at high speed.

The subfield coding circuit, the image signal processing circuit, and the plasma display of the present invention allow a reduction in the area of the LSI chip.

### BRIEF DESCRIPTION OF THE DRAWINGS

FIG. 1 is a block diagram showing the configuration of an image signal processing circuit (a first prior art example);

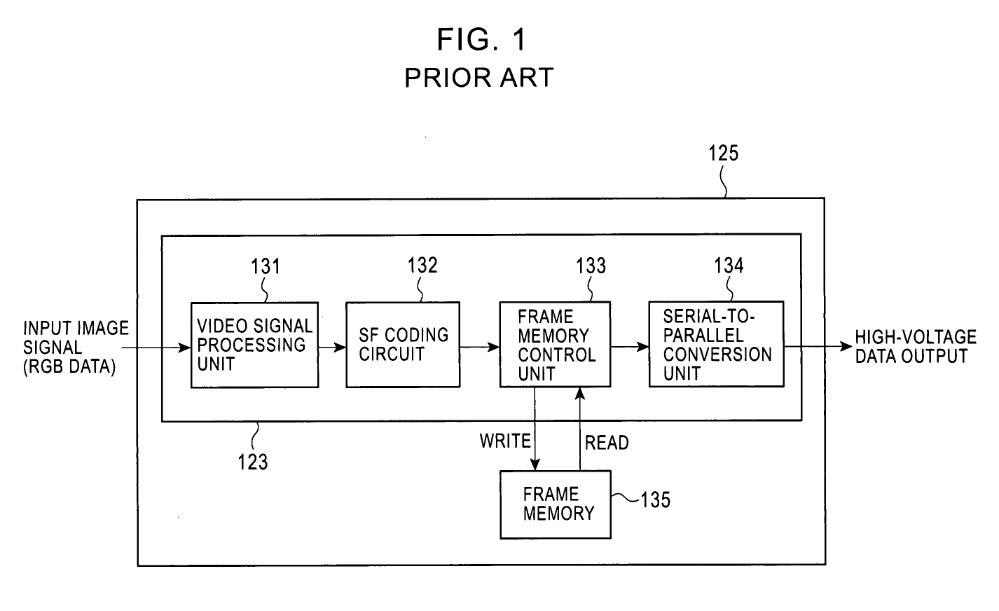

FIG. 2 is a block diagram showing the structure of a subfield (SF) coding circuit in the image signal processing circuit (the first prior art example);

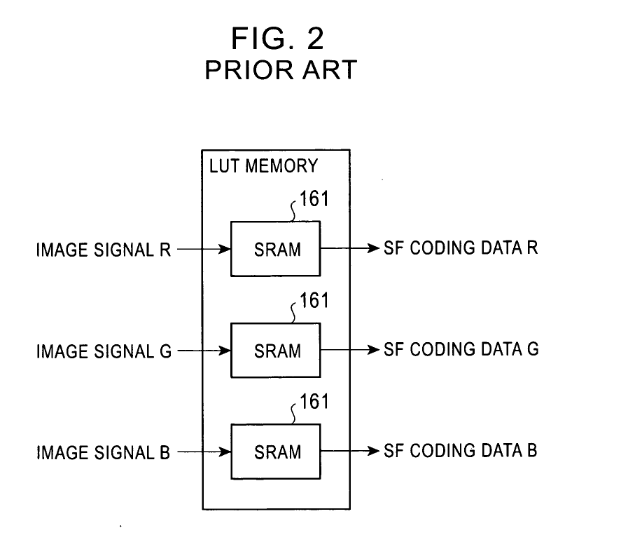

FIG. 3 is a diagram showing the timing of a subfield display method;

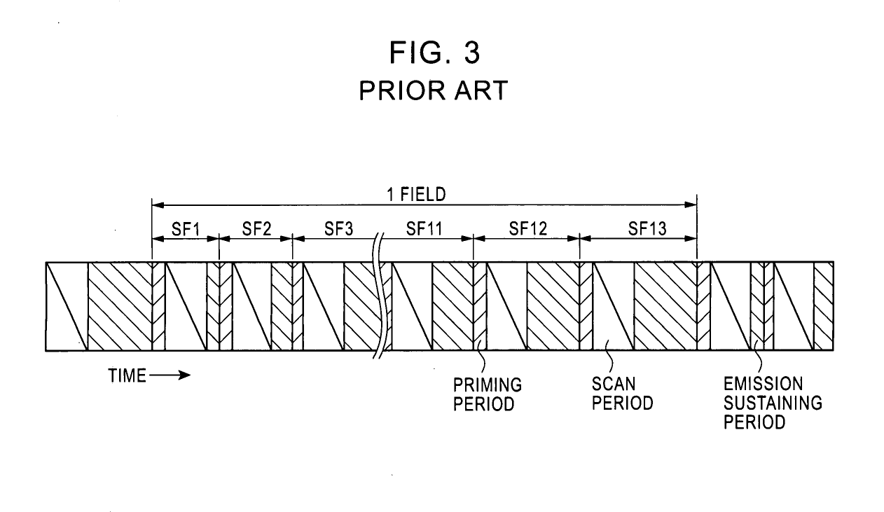

FIG. 4 is a block diagram showing the configuration of an image signal processing circuit (a second prior art example);

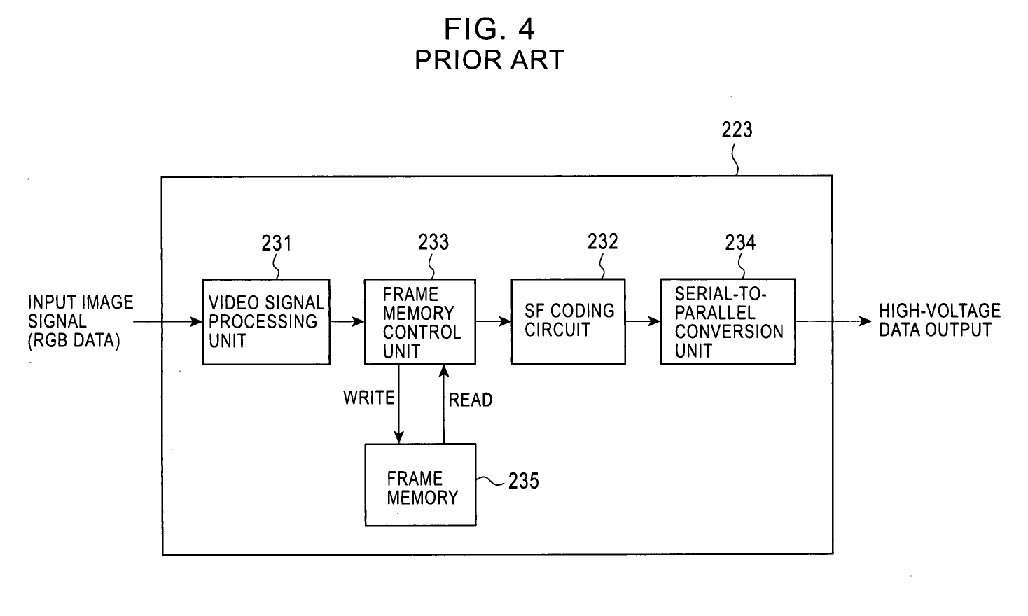

FIG. 5 is a block diagram showing the configuration of a plasma display (the present invention);

FIG. 6 is a flowchart showing the operation of an image signal processing circuit of the plasma display according to the present invention;

FIG. 7 is a diagram showing an example of setting subfield (SF) coding data written to a subfield (SF) coding cache memory in the image signal processing circuit of the plasma display according to the present invention;

FIG. 8 is a timing chart showing the operation of a subfield (SF) coding circuit in the display signal processing circuit of the plasma display according to the present invention; and

FIG. 9 is a diagram showing the configuration of the subfield (SF) coding circuit in the display signal processing circuit of the plasma display according to the present invention.

### DETAILED DESCRIPTION OF THE INVENTION

Hereinafter, the best mode for carrying out the plasma display according to the present invention will be described with reference to the accompanying drawings.

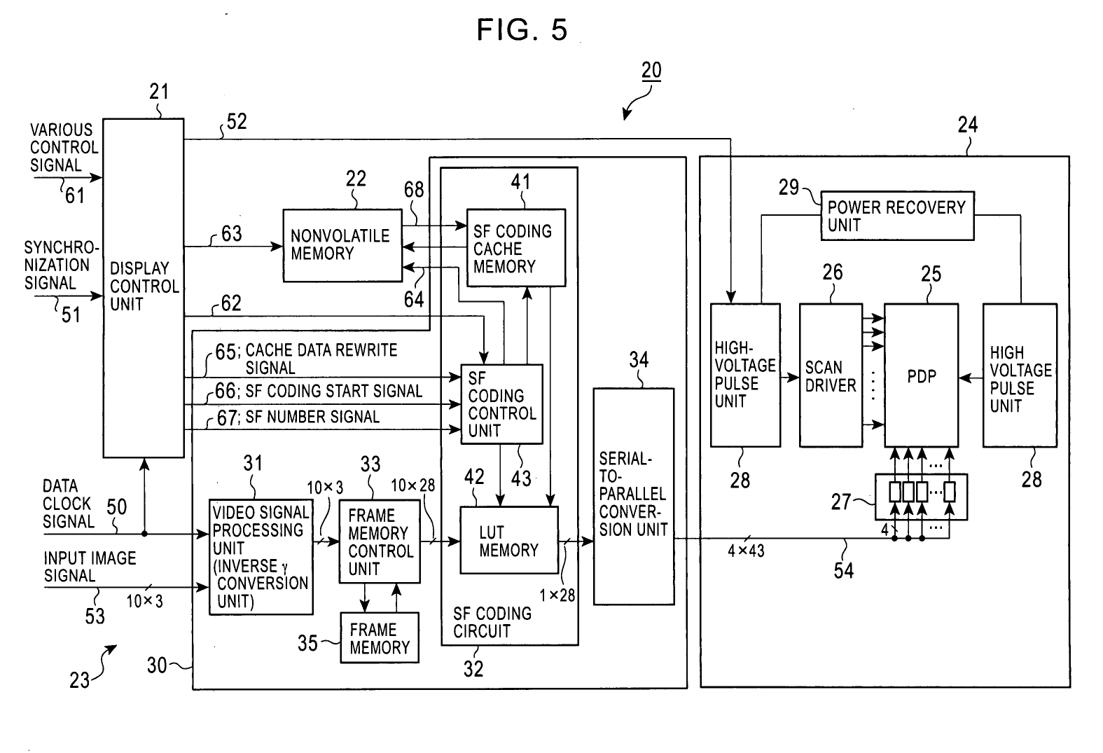

FIG. 5 is a block diagram showing the configuration of a plasma display 20 according to the present invention. The plasma display 20 of the present invention includes a display control unit 21, an image signal processing circuit 30, and a display device (display unit) 24. The image signal processing circuit 30 is implemented on a signal processing LSI 23 (signal processing LSI chip 23).

A data clock signal 50 is input to the display control unit 21 and the image signal processing circuit 30.

A synchronization signal 51 is input to the display control unit 21. The display control unit 21 outputs a scan driver control signal 52 to the display device 24 in accordance with the data clock signal 50 and the synchronization signal 51.

Input image signals 53 are input to the image signal processing circuit 30. The image signal processing circuit 30 converts the input image signals 53 into data driver control signals 54, and outputs the same to the display device 24.

The display device 24 includes a plasma display panel (PDP) 25, a scan driver 26, a data driver 27, high-voltage pulse units 28, and a power recovery unit 29.

The high-voltage pulse units 28 supply pulsed voltages to the PDP 25 and the scan driver 26.

The PDP 25 has pixels arranged in a matrix. Scan electrodes are provided on the rows, and data electrodes on the columns.

The scan driver control signal 52 from the display control unit 21 is input to the scan driver 26 through the high-voltage pulse unit 28. The scan driver 26 controls and drives the scan electrodes in accordance with the scan driver control signal 52.

The data driver control signals 54 from the image signal processing circuit 30 are input to the data driver 27. The data driver 27 controls and drives the data electrodes in accordance with the data driver control signals 54.

The PDP 25 displays a desired image by turning on or turning off predetermined pixels among those arranged in a matrix, based on the control of the scan electrodes by the scan driver 26 and the control of the data electrodes by the data driver 27.

The image signal processing circuit 30 includes a video signal processing unit 31, a subfield (SF) coding circuit 32, a frame memory control unit 33, a serial-to-parallel conversion unit 34, and a frame memory 35. The frame memory 35 (also referred to as frame buffer) is made of a dynamic random access memory (DRAM) for the sake of securing the memory capacity defined by the foregoing equation (3).

The plasma display 20 of the present invention applies redundancy coding for the sake of, e.g., 10-bit gradation rendering. The redundancy coding is applied so that n>log₂ N holds, where N is the number of gradations (gradation levels) of the image signals (input image signals), and n is the number of subfields (SFs) included in a single frame. Here, the number n of SFs is set at 13.

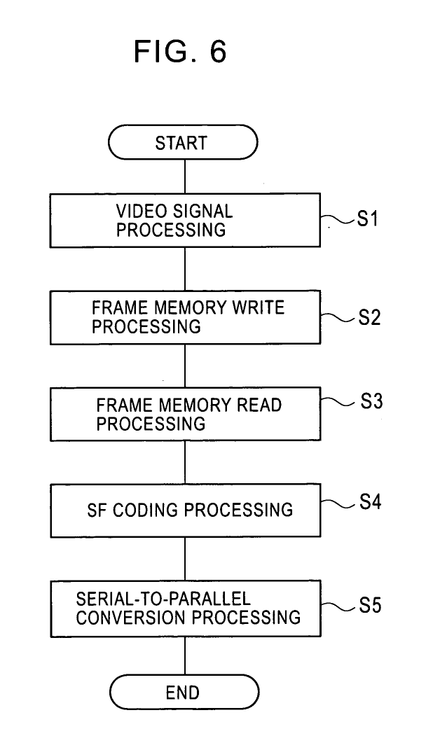

The operation of the image signal processing circuit 30 will now be described with reference to FIGS. 5 and 6. FIG. 6 is a flowchart showing the operation of the image signal processing circuit 30 of the plasma display 20 according to the present invention.

A single frame (a screenful) of input image signals for representing R (red), G (green), and B (blue) are input to the signal processing LSI 23. These input image signals (image signals) are already given gamma conversion. The video signal processing unit 31 applies video signal processing to the input image signals (step S1). In the video signal processing (step S1), the video signal processing unit 31 performs inverse gamma conversion on the input image signals, applies gradation processing to the image signals given the inverse gamma conversion, and outputs the resultant to the frame memory control unit 33. The gradation processing uses known dither and error diffusion methods.

The frame memory control unit 33 performs frame memory write processing (step S2) and frame memory read processing (step S3).

In the frame memory write processing (step S2), the frame memory control unit 33 converts the image signals from the video signal processing unit 31 into signals suitable for write to the frame memory 35, and writes (temporarily stores) them into the frame memory 35.

In the frame memory read processing (step S3), the frame memory control unit 33 reads the image signals temporarily stored in the frame memory 33 at predetermined timing scan line by scan line, and outputs the same to the SF coding circuit 32.

The SF coding circuit 32 applies SF coding processing to the image signals from the frame memory control unit 33 (step S4). In the SF coding processing (step S4), the SF coding circuit 32 converts the image signals from the frame memory control unit 33 into SF coding data, and outputs the same to the serial-to-parallel conversion unit 34. The SF coding processing (step S4) will be described later in detail.

The serial-to-parallel conversion unit 34 applies serial-to-parallel conversion processing to the SF coding data from the SF coding circuit 32 (step S5). In the serial-to-parallel conversion processing (step S5), the serial-to-parallel conversion unit 34 converts the SF coding data from the SF coding circuit 32 into data configured as required by the data driver 27, and outputs it to the data driver 27 as the foregoing data driver control signals 54.

The frame memory 35 (DRAM) on the DRAM-implemented LSI chip (signal processing LSI chip 23) is capable of high speed operation (parallel accesses at high speed in particular), and has a greater number of ports. Its maximum possible memory capacity, however, is not as high as that of a dedicated DRAM chip [external memory; the frame memory 135 (DRAM) according to the first prior art example]. According to the plasma display 20 of the present invention, the SF coding circuit 32 is arranged after the frame memory 35. This can reduce the memory capacity required of the frame memory 35 (DRAM) as compared to that of the frame memory 135 (DRAM) in the foregoing first prior art example. Take, for example, the case of W-XGA display with 1365 pixels per scan line and 768 lines per frame. Given the input image signals are in 10 bits and the number of division of SFs is 13, it is derived from the foregoing equation (3) that the memory capacity required of the frame memory 35 (DRAM) of the present invention is 60 Mb. Consequently, according to the plasma display 20 of the present invention, the memory capacity required of the frame memory 35 (DRAM) is reduced by 18 Mb as compared to the memory capacity of 78 Mb which is required of the frame memory 135 (DRAM) according to the first prior art example.

In the plasma display 20 of the present invention, the SF coding circuit 32 has a static random access memory (SRAM). The SRAM is used as a look-up table (LUT) memory for performing SF coding processing. Since the SF coding circuit 32 is arranged after the frame memory 35, the SRAM of the SF coding circuit 32 to be used as the LUT memory may increase in memory capacity. This requires a reduction of the memory capacity inside the SF coding circuit 32.

The plasma display 20 of the present invention further includes a nonvolatile memory 22. The nonvolatile memory 22 contains setting SF coding data for various modes. The various modes include power-on time and resetting time. The setting SF coding data establishes association between setting gradation values, or predetermined gradation values of the image signals, and SF coding data SF by SF.

The image signal processing circuit 30 includes an SF coding cache memory 41, an SF coding memory 42, and an SF coding control unit 43. An example of the SF coding memory 42 is a static random access memory (SRAM). The SF coding memory 42 (SRAM) is used as a look-up table (LUT) memory. Hereinafter, the SF coding memory 42 will be referred to as LUT memory 42.

The display control unit 21 receives a various control signal 61 which indicates one mode (display mode) out of the various modes. The display control unit 21 outputs an instruction signal 62 to the SF coding control unit 43 in accordance with the various control signal 61. The instruction signal 62 is intended to read setting SF coding data 68 corresponding to the display mode from the nonvolatile memory 22 and write the same to the SF coding cache memory 41. In the meantime, the display control unit 21 outputs an instruction signal 63 to the nonvolatile memory 22 in accordance with the various control signal 61. The instruction signal 63 is intended to designate the upper address of the nonvolatile memory 22 corresponding to the display mode. The SF coding control unit 43 outputs an instruction signal 64 to the nonvolatile memory 22 in accordance with the instruction signal 62. The instruction signal 64 is intended to designate the lower address of the nonvolatile memory 22 corresponding to the display mode. In the meantime, the display control unit 43 controls the SF coding cache memory 41 in accordance with the various control signal 62 so that the setting SF coding data 68 corresponding to the display mode is read from the nonvolatile memory 22 and written to the SF coding cache memory 41.

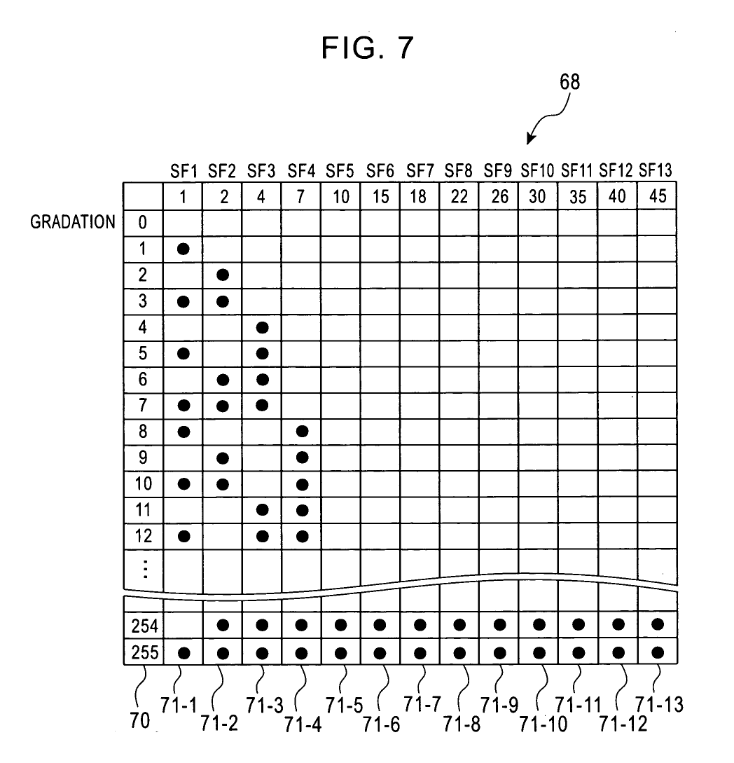

FIG. 7 shows an example of the setting SF coding data 68 written on the SF coding cache memory 41. The setting SF coding data 68 establishes association between the setting gradation values 70 mentioned above and pieces of SF coding data 71-1 to 71-13 corresponding to SF1 to SF 13.

The setting SF coding data 68 associates a single set of SFs (SF1 to SF13) with weights, and shows the order of display of the weighted SFs. For example, the SF coding data 71-1 associates SF1 with a weight of “1.” The SF coding data 71-2 associates SF2 with a weight of “2.” The SF coding data 71-3 associates SF3 with a weight of “4.” The SF coding data 71-4 associates SF4 with a weight of “7.” The SF coding data 71-5 associates SF5 with a weight of “10.” The SF coding data 71-6 associates SF6 with a weight of “15.” The SF coding data 71-7 associates SF7 with a weight of “18.” The SF coding data 71-8 associates SF8 with a weight of “22.” The SF coding data 71-9 associates SF9 with a weight of “26.” The SF coding data 71-10 associates SF10 with a weight of “30.” The SF coding data 71-11 associates SF11 with a weight of “35.” The SF coding data 71-12 associates SF12 with a weight of “40.” The SF coding data 71-13 associates SF13 with a weight of “45.”

The setting SF coding data 68 further associates gradations (setting gradation values 70) with combinations of SFs selected from among the set of SFs. For example, when the setting gradation value 70 shows “1,” the combination is composed of the SF coding data 71-1. When the setting gradation value 70 shows “2,” the combination is composed of the SF coding data 71-2. When the setting gradation value 70 shows “3,” the combination is composed of the SF coding data 71-1 and 71-2. When the setting gradation value 70 shows “4,” the combination is composed of the SF coding data 71-3. When the setting gradation value 70 shows “5,” the combination is composed of the SF coding data 71-1 and 71-3. When the setting gradation value 70 shows “6,” the combination is composed of the SF coding data 71-2 and 71-3. When the setting gradation value 70 shows “7,” the combination is composed of the SF coding data 71-1, 71-2, and 71-3. When the setting gradation value 70 shows “8,” the combination is composed of the SF coding data 71-1 and 71-4. When the setting gradation value 70 shows “9,” the combination is composed of the SF coding data 71-2 and 71-4. When the setting gradation value 70 shows “10,” the combination is composed of the SF coding data 71-1, 71-2, and 71-4. When the setting gradation value 70 shows “11,” the combination is composed of the SF coding data 71-3 and 71-4. When the setting gradation value 70 shows “12,” the combination is composed of the SF coding data 71-1, 71-3, and 71-4. When the setting gradation value 70 shows “254,” the combination is composed of the SF coding data 71-2 to 71-13. When the setting gradation value 70 shows “255,” the combination is composed of the SF coding data 71-1 to 71-13.

Now, the SF coding processing (step S4) mentioned above will be detailed with reference to FIGS. 5 to 8.

The display control unit 21 outputs a cache data rewrite signal 65, an SF coding start signal 66, and an SF number signal 67 to the SF coding control unit 43 at predetermined timing SF by SF. The SF number signal 67 represents the order (numbers) of SFs.

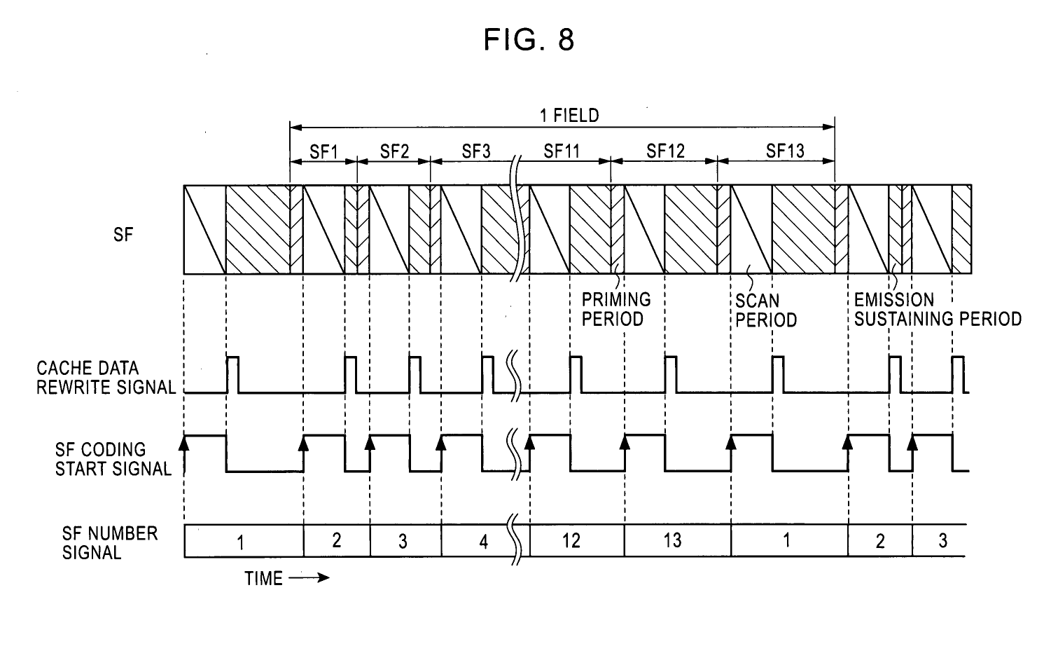

FIG. 8 is a timing chart showing the operation of the SF coding circuit 32. SF1 to SF13 each includes a priming period, a scan period (display data write period), and an emission sustaining period. The display control unit 21 recognizes the priming periods, the scan periods (display data write periods), and the emission sustaining periods of SF1 to SF13. The display control unit 21 recognizes the predetermined timing (in units of each single scan line) at which the frame memory control unit 33 outputs the image signals temporarily stored in the frame memory 35.

The display control unit 21 outputs the SF number signal 67 of “1,” which indicates an SF number of “1,” to the SF coding control unit 43 from the start of the scan period of SF13 to the end of the emission sustaining period thereof.

Next, the display control unit 21 outputs the cache data rewrite signal 65, in the form of a one-shot pulse, to the SF coding control unit 43 simultaneously with the start of the emission sustaining period of SF13. In accordance with the cache data rewrite signal 65 and the SF number signal 67 of “1,” the SF coding control unit 43 reads the setting gradation values 70 and the SF coding data 71-1 from the SF coding cache memory 41, and writes the same to the LUT memory 42.

Next, the display control unit 21 outputs the SF coding start signal 66 to the SF coding control unit 43 during the scan period of the next field, or SF1. In accordance with the SF coding start signal 66, the SF coding control unit 43 accesses the LUT memory 42 with the gradation values of the image signals from the frame memory control unit 33 as addresses. Consequently, the SF coding data 71-1 from among the setting gradation values (70) which corresponds to the gradation value of the image signal from the frame memory control unit 33 is output. For example, when an image signal from the frame memory control unit 33 has a gradation value of “3,” the SF coding control unit 43 outputs the SF coding data 71-1 of “1” which corresponds to the gradation value “3” of the image signal.

The display control unit 21 outputs the SF number signal 67 of “2,” which indicates an SF number of “2,” to the SF coding control unit 43 from the start of the scan period of the next field, or SF1, to the end of the emission sustaining period thereof.

Next, the display control unit 21 outputs the cache data rewrite signal 65, in the form of a one-shot pulse, to the SF coding control unit 43 simultaneously with the start of the emission sustaining period of SF1. In accordance with the cache data rewrite signal 65 and the SF number signal 67 of “2,” the SF coding control unit 43 reads the setting gradation values 70 and the SF coding data 71-2 from the SF coding cache memory 41, and writes the same to the LUT memory 42.

Next, the display control unit 21 outputs the SF coding start signal 66 to the SF coding control unit 43 during the scan period of SF2. In accordance with the SF coding start signal 66, the SF coding control unit 43 accesses the LUT memory 42 by using the gradation values of the image signals from the frame memory control unit 33 as addresses. Consequently, the SF coding data 71-2 corresponding to the gradation values of the image signals from the frame memory control unit 33 is output. For example, when an image signal from the frame memory control unit 33 has a gradation value of “3,” the SF coding control unit 43 outputs the SF coding data 71-2 of “2” which corresponds to the gradation value “3” of the image signal.

From the start of the scan period of SFi (i=1, 2, . . . , 13) to the end of the emission sustaining period of the same, the display control unit 21 outputs the SF number signal 67 of “j,” which indicates an SF number of “j” (j=i+1; if j=14, then j=1), to the SF coding control unit 43.

Next, the display control unit 21 outputs the cache data rewrite signal 65, in the form of a one-shot pulse, to the SF coding control unit 43 simultaneously with the start of the emission sustaining period of SFi. In accordance with the cache data rewrite signal 65 and the SF number signal 67 of “j,” the SF coding control unit 43 reads the setting gradation values 70 and the SF coding data 71-j from the SF coding cache memory 41, and writes the same to the LUT memory 42.

Next, the display control unit 21 outputs the SF coding start signal 66 to the SF coding control unit 43 during the scan period of SFj. In accordance with the SF coding start signal 66, the SF coding control unit 43 accesses the LUT memory 42 by using the gradation values of the image signals from the frame memory control unit 33 as addresses. Consequently, the SF coding data 71-j corresponding to the gradation value of the image signal from the frame memory control unit 33 is output.

According to the plasma display 20 of the present invention, the SF coding circuit 32 (SF coding control unit 43) reads the setting gradation values 70 and the SF coding data from the SF coding cache memory 41 and writes the same to the LUT memory 42 SF by SF. It also accesses the LUT memory 42 by using the gradation values of the image signals from the frame memory control unit 33 as addresses, so that the SF coding data from among the setting gradation values (70) corresponding to the gradation value of the image signal input to the LUT memory 42 is output to the serial-to-parallel conversion unit 34. Consequently, according to the plasma display 20 of the present invention, the LUT memory 42 is given a memory capacity as much as a single SF. This can reduce the memory capacity inside the SF coding circuit 32 (the total memory capacity of the SF coding circuit 32). Consequently, the memory capacity inside the image signal processing circuit 30 can be reduced. That is, it is possible to reduce the memory capacity inside the plasma display 20 of the present invention.

Now, with reference to FIGS. 5 to 9, the reduction of the memory capacity in the SF coding circuit 32 will be described in numerical terms.

For 10-bit gradation rendering, a single frame (a screenful) of input image signals (image signals), in which the gradation of each single pixel is expressed in 10 bits×3 (RGB), are input to the video signal processing unit 31. The video signal processing unit 31 performs inverse gamma conversion on the input image signals (10 bits×3), applies gradation processing thereto, and outputs the resultant to the frame memory control unit 33 (step S1: video signal processing).

The frame memory control unit 33 writes the image signals (10 bits×3) from the video signal processing unit 31 to the frame memory 35 (step S2: frame memory write processing).

The frame memory control unit 33 reads image signals corresponding to a single scan line (10 bits×28) out of the image signals (10 bits×3) written in the frame memory 35 at predetermined timing. Since the single frame (a screenful) of image signals are written to the frame memory 35 once, and read from the frame memory 35 in as many times as the number of SFs (13 times, in the present embodiment), the read operations must be performed at high speed. The frame memory control unit 33 outputs the read image signals (10 bits×28) to the LUT memory 42 of the SF coding circuit 32 (step S3: frame memory read processing).

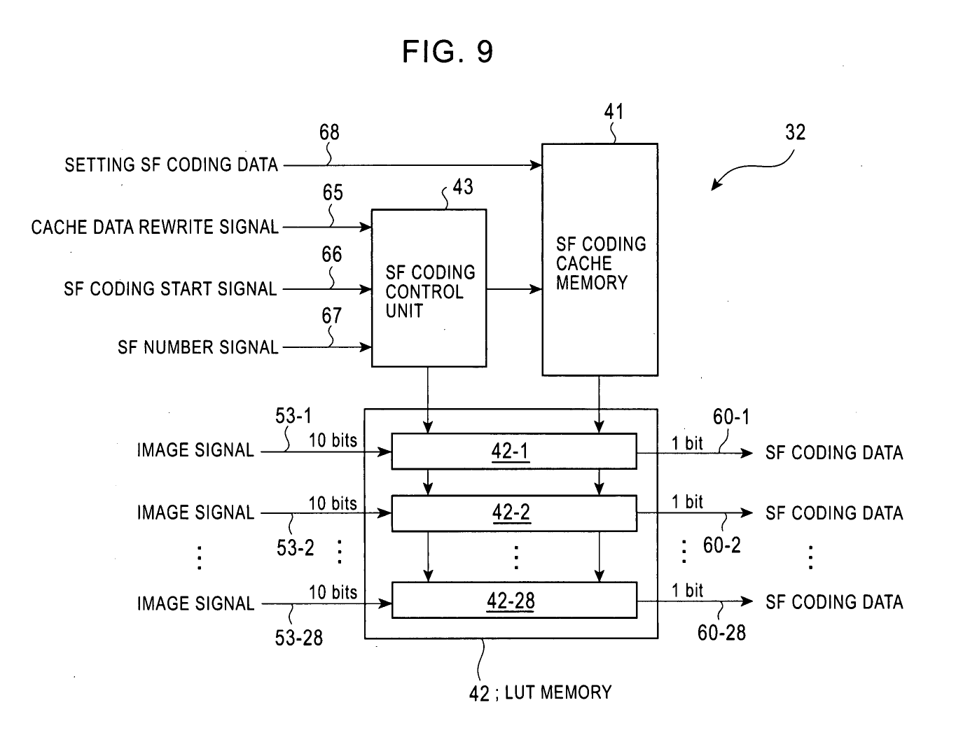

As shown in FIG. 9, the LUT memory 42 of the SF coding circuit 32 has 28 memory blocks, or memory units 42-1 to 42-28. The memory units 42-1 to 42-28 each have a memory capacity of 1 Kbits, and make a 10-bit input and a 1-bit output. For high speed operation, the SF coding circuit 32 (LUT memory 42) performs the foregoing SF coding processing in 28 parallel blocks. The SF coding cache memory 41, if were provided with 28 memory blocks, might cause an increase in memory capacity. Then, the SF coding cache memory 41 is formed for a single system alone, and the LUT memory 42 is provided with 28 memory blocks with a reduction in memory capacity. The foregoing image signals (10 bits×28), or image signals 53-1 to 53-28 (10 bits×28), are thus output to the memory units 42-1 to 42-28 of the LUT memory 42, respectively.

In accordance with the cache data rewrite signal 65 and the SF number signal 67 of “j” from the display control unit 21, the SF coding control unit 43 of the SF coding circuit 32 reads the setting gradation values 70 and the SF coding data 71-j from the SF coding cache memory 41, and writes the same to the memory units 42-1 to 42-28 of the LUT memory 42. The memory units 42-1 to 42-28 are thus written with the same contents (the setting gradation value 70 and the SF coding data 71-j). In accordance with the SF coding start signal 66 from the display control unit 21, the SF coding control unit 43 accesses the memory units 42-Y (Y=1, 2, . . . , 28) of the LUT memory 42 with the gradation values of the image signals from the frame memory control unit 33 as the addresses. The SF coding data 71-1 (1 bits×1) among the setting gradation values (70) corresponding to the gradation values of the image signals 53-Y (10 bits×1) from the frame memory control unit 33 is thus output to the serial-to-parallel conversion unit 34 as the SF coding data 60-Y (step S4: SF coding processing).

The PDP 25 for W-XGA display has 1365 pixels, or 1365×3 display elements, per scan line. This requires 1365×3 data drivers. Since 96 data drivers are typically packed into one LSI, 43 data driver LSIs are arranged as the data driver 27. Typical data driver LSIs are of 4-bit input, and perform serial-to-parallel conversion inside. The serial-to-parallel conversion unit 34 thus inputs the 28 bits of SF coding data [SF coding 60-1 to 60-28 (1 bits×1)] output from the LUT memory 42 under the control of the SF coding control unit 43 in a parallel fashion. The serial-to-parallel conversion unit 34 then outputs 43×4 bits of SF coding data to the data driver 27 in parallel as the foregoing data driver control signals 54 (step S5: serial-to-parallel conversion processing).

The data driver 27 writes the 1365×3 bits of SF coding data to the corresponding display elements scan line by scan line. The data driver 27 usually writes a single frame (a screenful) of SF coding data from the top (first) scan line on the display screen to the bottom (768th) scan line in succession, before the plasma display 20 enters an emission sustaining period.

Take, for example, the case of W-XGA display with 1365 pixels per scan line and 768 lines per frame, where the input image signals are in 10 bits, the number of division of SFs is 13, the scan cycle is 1 μs, and the operating speed of the frame memory 35 is 300 MHz. Then, the SF coding cache memory 41 is given a memory capacity of 13 Kbits, the LUT memory 42 (SRAM) a memory capacity of 28 Kbits (1 Kbits×28), and the SF coding circuit 32 an internal memory capacity of 41 Kbits (the total memory capacity of the SF coding circuit 32). Consequently, according to the plasma display 20 of the present invention, the memory capacity inside the SF coding circuit 32 is reduced to 1/9 as compared to the memory capacity of 364 Kbits inside the SF coding circuit 232 of the image signal processing circuit according to the second prior art example.

From the foregoing description, it is shown that according to the plasma display 20 of the present invention, the LUT memory 42 is given a memory capacity as much as a single SF. This allows a reduction of the memory capacity inside the SF coding circuit 32 (the total memory capacity of the SF coding circuit 32).

As described above, the frame memory 35 (DRAM) on the DRAM-implemented LSI chip (signal processing LSI chip 23) is capable of high speed operation (parallel accesses at high speed in particular), and has a greater number of ports. Its maximum possible memory capacity, however, is not as high as that of a dedicated DRAM chip [external memory; the frame memory 135 (DRAM) according to the first prior art example]. According to the plasma display 20 of the present invention, the SF coding circuit 32 is arranged after the frame memory 35. This can reduce the memory capacity required of the frame memory 35 (DRAM) as compared to that of the frame memory 135 (DRAM) of the foregoing first prior art example. Since the SF coding circuit 32 is arranged after the frame memory 35, however, the LUT memory (SRAM) of the SF coding circuit 32 may increase in memory capacity. According to the plasma display 20 of the present invention, the memory capacity of the LUT memory 42 (SRAM) in the SF coding circuit 32 is further reduced so that the image signal processing circuit 30 implemented on the signal processing LSI chip 23 can be operated at high speed.

According to the plasma display 20 of the present invention, the memory capacity required of the frame memory 35 (DRAM) and the memory capacity inside the SF coding circuit 32 both can be reduced. It is therefore possible to reduce the area of the signal processing LSI chip 23 by an amount corresponding to the reduction in the memory capacity.

According to the plasma display 20 of the present invention, the reduced area of the signal processing LSI chip 23 allows a reduction in the cost (for example, manufacturing cost) of the signal processing LSI chip 23.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2004-034271 which is hereby incorporated by reference.

1. A subfield coding circuit comprising:
a cache memory in which setting gradation values and subfield coding data are stored in association with each other subfield by subfield, said setting gradation values being predetermined gradation values of an image signal;
a subfield coding memory to which an image signal is input; and
a subfield coding control unit which reads said setting gradation values and said subfield coding data from said cache memory for writing to said subfield coding memory for each of said subfields, wherein
said subfield coding control unit accesses said subfield coding memory with the gradation value of said input image signal as an address, and outputs subfield coding data among said setting gradation values corresponding to the gradation value of said input image signal for each of said subfields.

2. The subfield coding circuit according to claim 1, wherein:
a cache data rewrite signal is input to said subfield coding control unit for each of said subfields; and
said subfield coding control unit reads said setting gradation values and said subfield coding data from said cache memory for writing to said subfield coding memory in accordance with said cache data rewrite signal.

3. The subfield coding circuit according to claim 2, wherein:
a subfield number signal and said cache data rewrite signal are input to said subfield coding control unit with respect to each of said subfields; and
when said subfield number signal indicates a first subfield out of said subfields, said subfield coding control unit reads said setting gradation values and said subfield coding data corresponding to said first subfield indicated by said subfield number signal from said cache memory for writing to said subfield coding memory in accordance with said subfield number signal and said cache data rewrite signal.

4. The subfield coding circuit according to claim 3, wherein:
a subfield coding start signal is input to said subfield coding control unit for each of said subfields; and
said subfield coding control unit accesses said subfield coding memory with the gradation value of said input image . signal as an address in accordance with said subfield coding start signal, and outputs the corresponding subfield coding data.

5. The subfield coding circuit according to claim 4, wherein:
said subfield number signal and said cache data rewrite signal are input to said subfield coding control unit before a scan period of said first subfield; and
said subfield coding start signal is input to said subfield coding control unit during the scan period of said first subfield.

6. An image signal processing circuit comprising
a frame memory,
a frame memory control unit for storing an image signal into said frame memory, and reading and outputting said image signal stored in said frame memory scan line by scan line, and
a subfield coding circuit for applying subframe coding processing to said image signal from said frame memory control unit, and outputting the resultant to a display unit, and wherein:
said subfield coding circuit includes
a cache memory in which setting gradation values and subfield coding data are stored in association with each other subfield by subfield, said setting gradation values being predetermined gradation values of an image signal;
a subfield coding memory for inputting an image signal from said frame memory control unit, and
a subfield coding control unit for reading said setting gradation values and said subfield coding data from said cache memory and for writing to said subfield coding memory for each of said subfields; and
said subfield coding control unit accesses said subfield coding memory with the gradation value of said input image signal as an address, and outputs subfield coding data among said setting gradation values corresponding to the gradation value of said input image signal for each of said subfields.

7. The image signal processing circuit according to claim 6, wherein:
a cache data rewrite signal is input to said subfield coding control unit for each of said subfields; and
said subfield coding control unit reads said setting gradation values and said subfield coding data from said cache memory for writing to said subfield coding memory in accordance with said cache data rewrite signal.

8. The image signal processing circuit according to claim 7, wherein:
a subfield number signal and said cache data rewrite signal are input to said subfield coding control unit with respect to each of said subfields; and
when said subfield number signal indicates a first subfield out of said subfields, said subfield coding control unit reads said setting gradation values and said subfield coding data corresponding to said first subfield indicated by said subfield number signal from said cache memory and writes the same to said subfield coding memory in accordance with said subfield number signal and said cache data rewrite signal.

9. The image signal processing circuit according to claim 8, wherein:
a subfield coding start signal is input to said subfield coding control unit for each of said subfields; and
said subfield coding control unit accesses said subfield coding memory with the gradation value of said input image signal as an address in accordance with said subfield coding start signal, and outputs said corresponding subfield coding data.

10. The image signal processing circuit according to claim 9, wherein:
said subfield number signal and said cache data rewrite signal are input to said subfield coding control unit before a scan period of said first subfield; and
said subfield coding start signal is input to said subfield coding control unit during the scan period of said first subfield.

11. The image signal processing circuit according to claim 6, being implemented on an LSI chip.

12. The image signal processing circuit according to claim 11, wherein said frame memory is a dynamic random access memory (DRAM).

13. The image signal processing circuit according to claim 12, wherein said subfield coding memory is a static random access memory (SRAM).

14. A plasma display comprising
an image signal processing circuit, and
a display unit connected to said image signal processing circuit, and wherein:
said image signal processing circuit includes
a frame memory,
a frame memory control unit for storing an image signal into said frame memory, and reading and outputting said image signal stored in said frame memory scan line by scan line, and
a subfield coding circuit for applying subframe coding processing to said image signal from said frame memory control unit, and outputting the resultant to said display unit;
said subfield coding circuit includes
a cache memory in which setting gradation values and subfield coding data are stored in association with each other subfield by subfield, said setting gradation values being predetermined gradation values of an image signal;
a subfield coding memory to which said image signal from said frame memory control unit is input, and
a subfield coding control unit which reads said setting gradation values and said subfield coding data from said cache memory for writing to said subfield coding memory for each of said subfields; and
said subfield coding control unit accesses said subfield coding memory with the gradation value of said input image signal as an address, and outputs subfield coding data among said setting gradation values corresponding to the gradation value of said input image signal for each of said subfields.

15. The plasma display according to claim 14, further comprising a display control unit, wherein:
said display control unit outputs a cache data rewrite signal to said subfield coding control unit for each of said subfields; and
said subfield coding control unit reads said setting gradation values and said subfield coding data from said cache memory for writing to said subfield coding memory in accordance with said cache data rewrite signal.

16. The plasma display according to claim 15, wherein:
said display control unit outputs a subfield number signal and said cache data rewrite signal to said subfield coding control unit for each of said subfields; and
when said subfield number signal indicates a first subfield out of said subfields, said subfield coding control unit reads said setting gradation values and said subfield coding data corresponding to said first subfield indicated by said subfield number signal from said cache memory for writing to said subfield coding memory in accordance with said subfield number signal and said cache data rewrite signal.

17. The plasma display according to claim 16, wherein:
said display control unit outputs a subfield coding start signal to said subfield coding control unit for each of said subfields; and
said subfield coding control unit accesses said subfield coding memory with the gradation value of said input image signal as an address in accordance with said subfield coding start signal, and outputs said corresponding subfield coding data.

18. The plasma display according to claim 17, wherein said display control unit outputs said subfield number signal and said cache data rewrite signal to said subfield coding control unit before a scan period of said first subfield, and outputs said subfield coding start signal to said subfield coding control unit during said scan period of said first subfield.

19. The plasma display according to claim 14, wherein said image signal processing circuit is implemented on an LSI chip.

20. The plasma display according to claim 19, wherein said frame memory is a dynamic random access memory (DRAM).

21. The plasma display according to claim 20, wherein said subfield coding memory is a static random access memory (SRAM).
